(19) United States
(12) Patent Application Publication
(10) Pub. No.: US 2003/0026237 A1
(43) Pub. Date: Feb. 6, 2003

(54) Cellular base station architecture with soft partitioning

(76) Inventors: Behzad Barjesteh Mohebbi, Tustin, CA (US); Fadi Joseph Kurdahi, Irvine, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/211,253

(22) Filed: Aug. 2, 2002

Related U.S. Application Data
(60) Provisional application No. 60/310,776, filed on Aug. 6, 2001.

(51) Int. Cl. H04J 3/00

(52) U.S. Cl. 370/345

(57) ABSTRACT

A digital signal processing architecture and method for performing base band tasks of a cellular base transceiver station. A plurality of base band tasks is partitioned into sequential time elements of a dynamic processing schedule. A reconfigurable processor is sequentially programmed for performing each one of the plurality of base band tasks during an associated time element of the processing schedule. Thus, with a single hardware platform, the base band processing may be performed without burdens of hardware partitioning or software interface problems.

This patent application claims priority from U.S. Provisional Patent Application No. 60/310,776, filed Aug. 6, 2001.

### BACKGROUND OF THE INVENTION

The present invention generally relates to cellular communications and more particularly to a base band processing architecture for a base transceiver station (BTS) of a base station (BS).

Cellular base stations perform many functions using a variety of hardware devices such as application specific integrated circuits (ASICs), digital signal processors (DSPs), and general-purpose processors. Each of these devices has unique advantages and limitations. Cellular base station functionalities include radio frequency (RF) filtering, base-band operations such as modem, forward error correction (FEC) and source encoding/decoding, and mobility management (MM). Other functions include the control and monitoring of the base station itself Some or all of these functions are executed for various communication modes, including code division multiple access (CDMA), wideband CDMA (WCDMA), and the general packet radio services of time division multiple access (GPRS TDMA) modes.

These and other base station functions are accomplished in a number of base band processes or tasks, which have to be designed to avoid data flow “bottlenecks” which can result in a loss of capacity and/or processing resources. Accordingly, different tasks must be carefully partitioned among different hardware devices and software, which in turn must be dimensioned for a coherent flow of data throughout the base station.

FIG. 1 is a functional block diagram of a conventional single-channel receiver base band unit 100 for a cellular base station illustrating a typical hardware partitioning scheme. The base band unit 100 includes a root raised cosine (RRC) channel filter which is typically implemented on an application specific integrated circuit (ASIC) block, and carried out on the received signal only once for all the supported channels. The base band unit also includes a RAKE receiver function 104 which also needs to be implemented on a separate ASIC block. There is at least one RAKE receiver for each supported channel (n), which employs diversity to mitigate adverse effects of multipath, fading and co-channel interference. A demultiplexing (Demux) and deinterleaving function 106 and a forward error control (FEC) decoder function 108 are usually implemented on a cluster of digital signal processors (DSPs) with hardware accelerators. A source decoder function 110 may also be implemented in a DSP cluster.

The conventional base band unit 100 partitioned hardware scheme has a number of disadvantages. The ASIC implementation of the RAKE receiver function 104 does not flexibly allow modifications and/or improvements be made to the receiver algorithms. The FEC and decoder functions 108 usually require hardware accelerators which are implemented in an ASIC, imposing the same restrictions as with the RAKE ASICs. The DSP clusters must be dimensioned for a given number of channels (n) and associated mix of services. This imposes an ongoing inflexibility in the choice and mix of these services.

Other disadvantages exist with conventional functional and hardware partitioning. The DSP clusters must communicate with other DSPs and the ASIC blocks, and software implementing seamless communications is difficult to develop, if not impossible. Furthermore, the conventional channel architecture is not fully scalable. If more channels are required, another similar channel card must be added to the base station, leading to the same number and permutation of channels.

Accordingly, a more flexible and scalable architecture is needed for cellular base stations.

### BRIEF DESCRIPTION OF THE DRAWING

FIG. 1 is a functional block diagram of a conventional single-channel receiver base band unit.

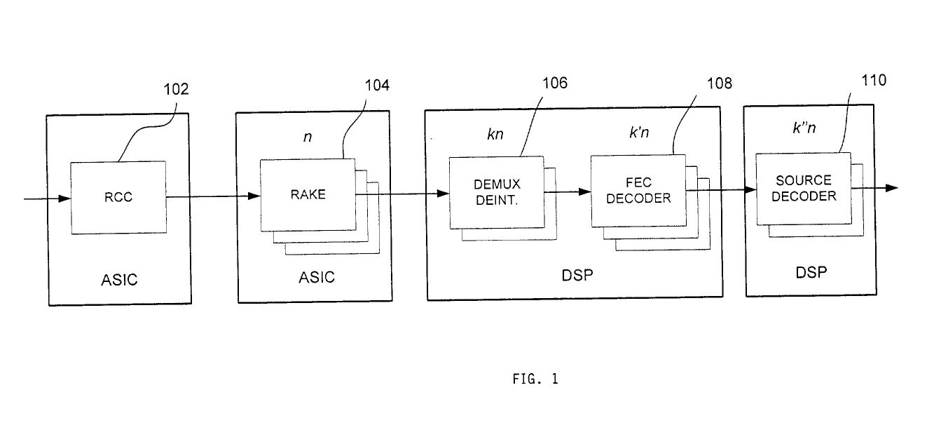

FIG. 2 is a functional block diagram of a multiple channel receiver base band unit according to one embodiment of the invention.

FIG. 3 is a block diagram of a reconfigurable processor array according to various aspects of the invention.

FIG. 4 is a timing diagram showing one example of process time scheduling, i.e. “soft partitioning.”

FIG. 5 is a timing diagram showing one example of dynamic process time scheduling for multi-mode operation.

### DETAILED DESCRIPTION OF THE PREFERRED EMBODIMENTS

An apparatus and method according to various aspects of the invention solves the aforementioned problems associated with hardware and software partitioning in a BTS receiver by employing a processing architecture without most or all of the partitioning. Accordingly, BTS base band tasks for each data flow channel are time multiplexed in a single reconfigurable processor, requiring neither hardware nor software partitioning. The apparatus and method enable the base station to be reconfigurable in real-time for different services by sequentially reconfiguring base band processing for different operating channels. The resultant architecture is highly scalable, as new channels can be added based on the same hardware design, without disturbing other parts of the base band operation. Furthermore, the architecture enables multi-mode and/or multiple standard processing on the single DSP platform.

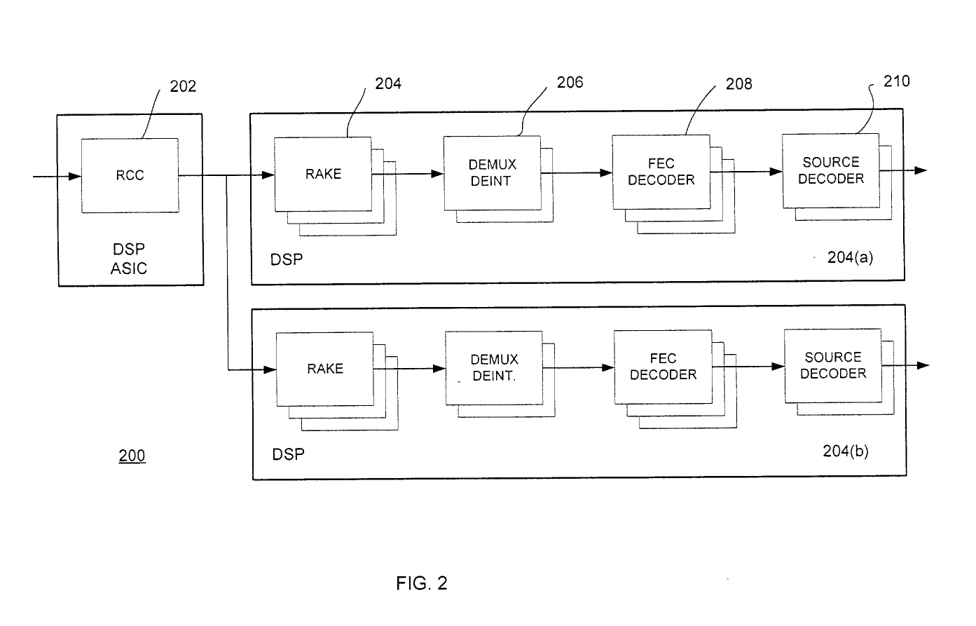

FIG. 2 is a functional block diagram of a multiple channel receiver base band unit 200 illustrating soft partitioning of base band tasks. The base band tasks include RRC filtering 202 and a plurality of processing for each one of a number of service channels designated as 204(a) and 204(b). Although two service channels are shown, there may be any number of service channels. All of the base band tasks of a receiver chain for each service channel 204(a) and 204(b) are performed on a single hardware unit, preferably a DSP. The RRC filter 202 may be implemented in an ASIC block, or as a separate DSP, or may be integrated in the single hardware unit for each service channel 204(a) and 204(b).

With reference to service channel 204(a) as an example, the base band tasks are partitioned sequentially into time elements and according to a processing schedule. The discreet time-partitioned tasks include RAKE receiver functions 206, followed by demultiplexing and deinterleaving 208, FEC and decoding 210, and source decoding 212. In accordance with one embodiment, a single reconfigurable processor is programmed to perform each of the tasks in sequence, and during an associated time element of the processing schedule.

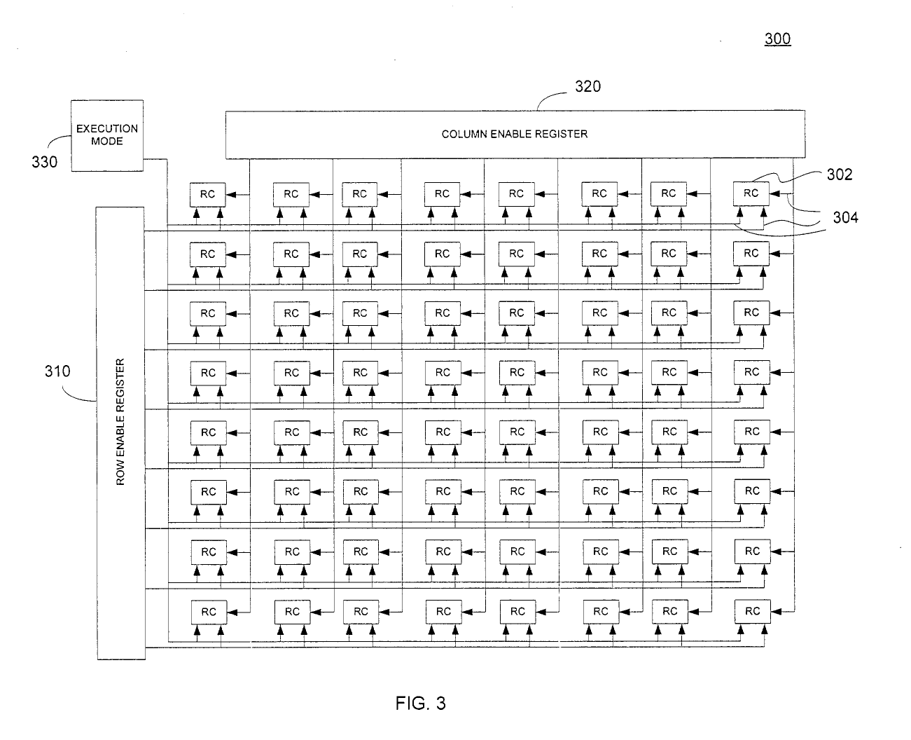

One type of reconfigurable processor that is capable for being programmed as described above includes an array of reconfigurable processing elements, such as a reconfigurable digital signal processor (rDSP) developed by Morpho Technologies, Inc. of Irvine Calif. FIG. 3 is a block diagram of an exemplary rDSP 300 on which each of the base band tasks may be performed. Specific embodiments of this type of reconfigurable processor array is described in U.S. patent applications Ser. Nos. 09/772,591, filed Jan. 29, 2001, and 09/776,981, filed Feb. 5, 2001, both being assigned to Morpho Technologies, Inc., the disclosures of which are hereby incorporated by reference in their entirety for all purposes. The processor array 300 includes an M row×N column array of independently reconfigurable processing elements 302. The processing elements 302 are interconnected by input/output paths 304, each of which may be enabled or disabled for a particular interconnection scheme. The non-configured processing elements 302 are disabled and powered down to conserve power.

Each processing element 302 includes one or more functional units, the configuration of which define a logical operation of the processing element. Each processing element 302 also includes a context register for storing an instruction for controlling the functional units, and an output register for storing temporary data, such as a result of computations or logical operations by the functional units.

The array of processing elements 302 is programmed by an instruction memory, which includes a row enable register 310, a column enable register 320, and an execution mode generator 330. The row enable register 310 enables each row of the array for being programmed, and the column enable register enables each column of the array for being programmed. The execution mode generator 330 programs processing elements 302 which are enabled by the row and column enable registers 310 and 320. The execution mode generator 330 and row and column enable registers are also controlled by a reduced instruction-set computer (RISC) processor and context memory (not shown). An exemplary reconfigurable processor array 300 utilizes sub-micron silicon technology to implement the array on a single chip.

To accomplish the base band functions of a BTS receiver, the array of processing elements is programmed to perform a first function on data during a first time element of a processing schedule, such as RAKE receiver functions for example. At least one individual processing element 302 is enabled and programmed for the duration of the first time element, and the entire array of processing elements may be enabled and programmed during the first time element. Non-enabled processing elements 302 may be powered down to conserve power. A result of the first function is saved in an output register (not shown). At a next time element of the processing schedule, the array of processing elements is programmed to perform a different function on the result of the first function. The first function result is accessed from the output register, and a result of the second function then stored in the output register. Each processing element 302 may have its own output register.

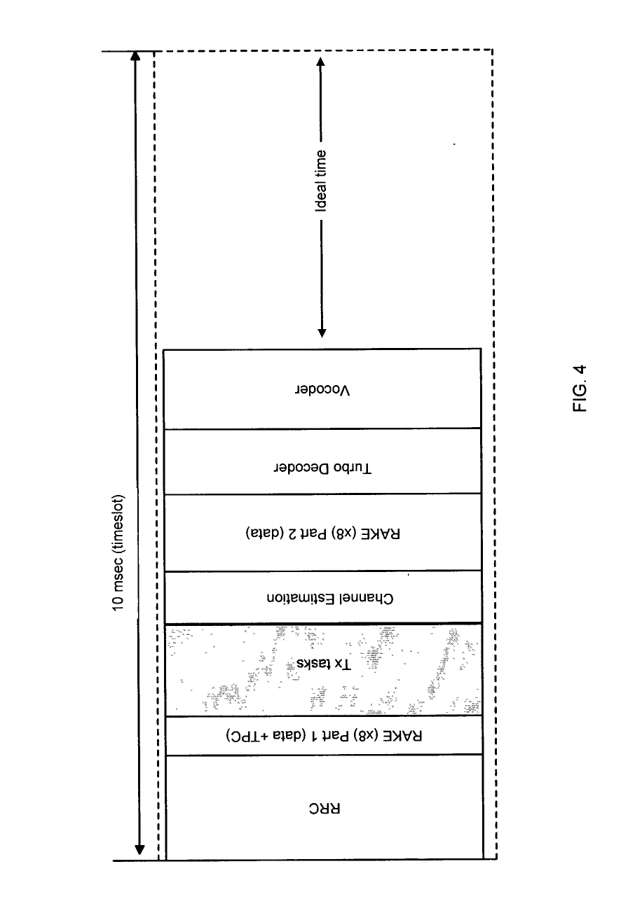

The base band tasks are time-scheduled in the order of data flow, to be performed within the allocated iteration time for real-time and non-real time services. Although only receiver functions have been shown and specifically discussed above, other base band tasks such as transmitter chain functions can also be performed in the remaining ideal time frame. FIG. 4 shows one example time frame including a processing schedule in which different base band tasks are partitioned in time. The example time frame in FIG. 4 corresponds to a 10 millisecond WCDMA processing iteration timeslot, but is not necessarily limited to such a timeslot.

Time scheduling of the base band tasks shown in FIG. 4 are flexible, i.e. the time elements may be variable or “soft,” and no process dimensioning is required since all of the required processes for a channel are carried out within a single reconfigurable processor. A reconfigurable processor such as the rDSP 300 in FIG. 3 is reconfigurable in real-time by uploading the appropriate firmware. Further, since the partitioning is soft, multi-mode base band processing for two or more different cellular standards can be supported.

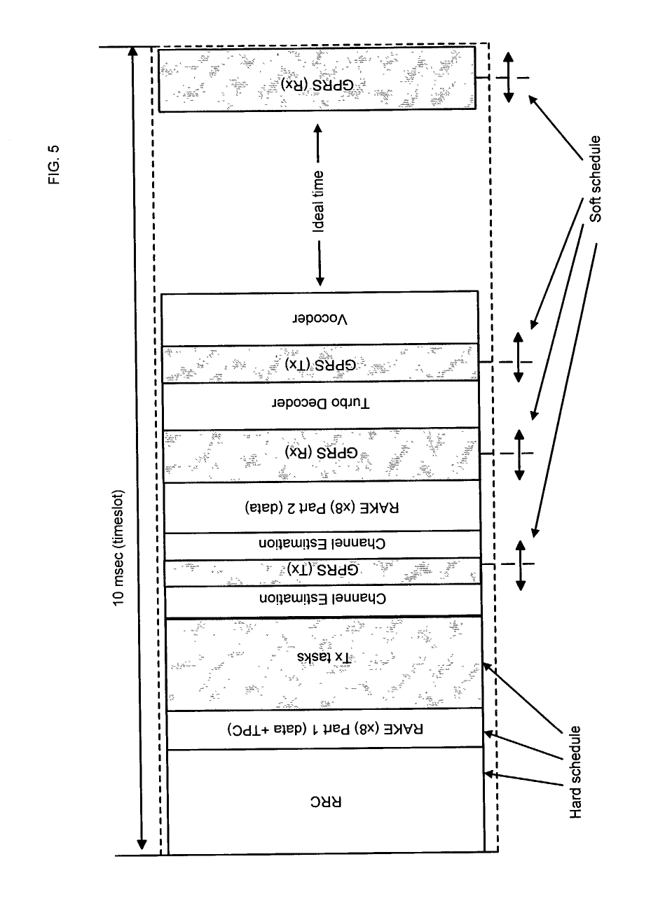

FIG. 5 shows one example of dynamic scheduling for multi-mode operation. In this implementation, due to the closed-loop power control mechanism of CDMA, some WCDMA tasks have to performed according to a predefined schedule (i.e. “hard schedule”). The GPRS TDMA standard allows for soft scheduling of tasks provided certain tasks are carried out before the deadline for prompt transmission and continuous received data flow. Although the GPRS iteration time of 4.615 milliseconds is not divisible into 10 millisecond time slots (the iteration time of a WCDMA frame), the use of dynamic scheduling makes it possible to arrange both WCDMA and GPRS base band processing with only a single DSP. This base band architecture is ideal for multi-mode Pico and Micro cellular base stations where the same DSP engine may be used for several different channels.

The granularity of each time element is also dynamic. A different granularity can be assigned to different processes based on the communication mode being used. For instance, some tasks can be carried out on one received symbol, while others may be performed on several symbols. The repetition or iteration rate can also be different for different tasks or processes. Accordingly, the processing schedule is not necessarily confined to any particular duration.

Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. A method of performing base band processing in a cellular base transceiver station, comprising:
partitioning a plurality of base band tasks into sequential time elements of a processing schedule; and
sequentially programming a reconfigurable processor for performing each one of the plurality of base band tasks during an associated time element of the processing schedule.

2. The method as set forth in claim 1, wherein the time elements include variable time elements.

3. The method as set forth in claim 1, wherein the time elements include fixed time elements.

4. The method as set forth in claim 1, wherein the base band tasks include receiving data.

5. The method as set forth in claim 1, wherein the base band tasks include transmitting data.

6. The method as set forth in claim 1, wherein the reconfigurable processor includes an array of independently reconfigurable processing elements.

7. The method as set forth in claim 3, wherein the time elements further include variable time elements.

8. The method as set forth in claim 7, wherein one or more of the fixed time elements correspond to WCDMA base band tasks.

9. The method as set forth in claim 7, wherein one or more of the variable time elements correspond to GPRS TDMA base band tasks.

10. The method as set forth in claim 1, wherein sequentially programming the reconfigurable processor includes programming the reconfigurable processor to perform the plurality of base band tasks continuously.

11. A method of performing base band processing in a multi-mode cellular base transceiver station, comprising:
partitioning a plurality of base band tasks of multiple cellular operation modes into sequential time elements of a multi-mode processing schedule, wherein the multi-mode processing schedule includes variable time elements and fixed time elements; and
sequentially programming a reconfigurable processor for performing each one of the plurality of base band tasks during an associated time element of the multi-mode processing schedule.

12. The method as set forth in claim 11, wherein the multiple cellular operation modes include WCDMA.

13. The method as set forth in claim 11, wherein the multiple cellular operation modes include GPRS TDMA.

14. The method as set forth in claim 11, wherein the reconfigurable processor includes an array of independently reconfigurable processing elements.

15. An apparatus for performing base band processing in a cellular base transceiver station, comprising:
a reconfigurable processor for performing a plurality of base band tasks; and
an instruction memory for programming the reconfigurable processor according to a processing schedule in which the plurality of base band tasks are partitioned into sequential time elements.

16. The apparatus as set forth in claim 15, wherein the reconfigurable processor includes an array of independently reconfigurable processing elements.

17. The apparatus as set forth in claim 16, wherein the instruction memory dedicates all of the processing elements to a single base band task during an associated time element.
